(19) United States
(12) Patent Application Publication
(10) Pub. No.: US 2014/0222797 A1
(43) Pub. Date: Aug. 7, 2014

(54) Collecting And Providing Information Online

(71) Applicant: Chian Chiu Li, Fremont, CA (US)

(72) Inventor: Chian Chiu Li, Fremont, CA (US)

(21) Appl. No.: 13/757,829

(22) Filed: Feb. 3, 2013

(51) Int. Cl. G06F 17/30

(52) U.S. Cl. CPC G06F 17/30867
USPC 707/724

(57) ABSTRACT

Online posts may be categorized or sorted by poster's geographic location. The posts may also be categorized or sorted by post mood polarity. The selected posts based on location or mood polarity may be summarized and then presented to users in a concise form. The geographic location information may be verified by poster's confirmation.

### CROSS REFERENCE TO RELATED APPLICATION

This application claims the benefit under 35 U.S.C. Sec. 119 of provisional patent application Ser. No. 61/598,353, filed Feb. 14, 2012.

### FEDERALLY SPONSORED RESEARCH

Not applicable

### SEQUENCE LISTING OR PROGRAM

Not applicable

### BACKGROUND

1. Field of Invention

This invention relates to information collection and presentation, more particularly to collection, processing and presentation of online information.

2. Description of Prior Art

The Internet has become a colossal reservoir of data where we try to keep almost everything digital, whose contents include knowledge, history, event, experience, action, or in some occasions, any digital signals we could catch. The Internet also provides us with a platform where a user can conveniently publish to the public or post his or her ideas or opinions. The opinions, for example, if generated by posters having experience of a product, would be very helpful for potential buyers. There are numerous web sites where a user can leave comments or posts, and there are many web sites whose main purpose is to let users express thoughts or opinions. As the volume of posts is large, a user may have to spend quite some time to find the information needed.

Posts on a subject are mostly displayed by the sequence of posting time. Sometimes, however, geographic information of poster is important to viewers. For example, travelers may be interested in opinions from people with a particular geographic background or cultural background, such as opinions regarding local food, local attraction, a cultural event, or performance of a product under certain climate conditions. When looking for comments on political or social issues regarding a region, it may be of interest to read more contents posted from that region. Accordingly, there exists a need to categorize or sort online posts by poster's geographic location.

A poster's geographic location information may be obtained by IP address of the computer in use. If a poster uses a mobile device, the location info of the device may be determined by the Global Positioning Service (“GPS”) or the wireless triangulation method. However, above methods may cause errors, since location info derived from IP address may not be accurate enough, and a mobile device user may be traveling around. Accordingly, there exists a need to confirm poster's geographic location.

Besides location, mood polarity of a post is also an important factor. A post with positive mood tends to provide a more positive view, reflecting a more positive attitude or feeling. Sometimes, we may want to see positive comments only. For example, when we want to glean information on the positive side of a product or event, we like to do it directly and quickly. Another example is of comments on heated political, environmental, or international issue, which usually divides posters into two sides; and a person may want to focus on opinions from one side first. Therefore, there also exists a need to categorize or sort online posts by post's mood polarity.

The term “web site” or “website” is broadly referred to any domain or subdomain or a domain plus a uniform resource locator prefix. The term “document” is referred broadly to any machine-readable and machine-storable information, or any information in a digital format, including textual information, a web page, image file, audio file, video file, other web documents, embedded information, etc. The word “registration” referred to account setup which a user may do or is required to do when visiting a web site or visiting a specific page of a web site. Information needed for setting up an account may include user name, email address, user location, and/or other information related to the user.

The word “post” as verb or “posting” is referred broadly as transmitting information from a user to a server via a network to let others in a certain environment view the transmitted information. The word “post” as noun includes information or document posted by a user on the Internet or user generated content. Posted information may cover a hyperlink or a uniform resource locator (URL), audio, video, an image, a symbol, a message, an e-mail, news article, blog entry, etc. In practice, a user may or may not be allowed to post information without registration. Posts are preferably hosted on a web site, but may also be hosted locally using local database or local server system. Posts are preferably used as a form of publishing own opinions and/or reviewing other's opinions, but may additionally or alternatively be used as a form of micro-blogging, data search and collection, messaging, gaming, and/or other suitable applications. Commonly posted information on a daily basis includes opinion, experience, comment, story, thought, claim, or expression on anything by textual, graphic, or other formats, which may be found among numerous web sites.

The term “mood” is broadly referred to emotion, sentiment, or a poster/user's feel of happiness or angriness, or, positive or negative attitude toward a subject like a service, product, news, event, action, activity, result, idea, opinion, geographic region, physical object, living object, etc.

### OBJECTS AND ADVANTAGES

Accordingly, several main objects and advantages of the present invention are:
a). to provide an improved system and method to process and present online posts;
b). to provide such a system and method which categorize or sort posts by geographic location information;
c). to provide such a system and method which categorize or sort posts by mood polarity;
d). to provide such a system and method which arrange users to confirm geographic location information.
e). to provide such a system and method which produce a summary of posts based on geographic location and/or mood polarity information.

Further objects and advantages will become apparent from a consideration of the drawings and ensuing description.

### SUMMARY

In accordance with the present invention, a number of posts may be retrieved from server systems and from the Internet in response to a search query. The retrieved posts may be categorized or sorted by poster's geographic location information. The posts may also be categorized or sorted by post mood polarity information. Next the categorized or sorted posts may be processed to generate a concise and easy to read summary. The summary may provide a short and clear answer to the query based on location or mood polarity. Geographic location information may be confirmed by user's feedback.

### DRAWING FIGURES

FIG. 1 is a block diagram showing a prior-art network environment.

FIG. 2 is a block diagram showing a prior-art server 16 of FIG. 1.

FIG. 3 is a schematic block diagram of a log processing system of a server in accordance with the present invention.

FIG. 4 is a schematic block diagram of a searching system of a server in accordance with the present invention.

FIG. 5 is a schematic flow diagram showing registration and location confirmation process in accordance with the present invention.

FIG. 6 is a schematic flow diagram showing posting process in accordance with the present invention.

FIG. 7 is a schematic flow diagram showing search result handling process in accordance with the present invention.

FIGS. 8-A and 8-B are exemplary column and pie charts showing search summaries based on location in accordance with the present invention.

FIGS. 9-A and 9-B are exemplary column and pie charts showing search summaries based mood polarity in accordance with the present invention.

FIG. 10 shows an exemplary column chart depicting a search summary based on both location and mood polarity.

FIG. 11 shows two exemplary curves of search summary based on mood polarity.

FIGS. 12 and 13 are exemplary diagrams showing a concise summary and summary based on mood polarity presented together.

FIG. 14 shows a list of search results and a summary based on mood polarity presented together.

FIGS. 15, 16, and 17 are exemplary diagrams each showing multiple search summaries based on mood polarity and/or location.

REFERENCE NUMERALS IN DRAWINGS

| | | | |
|---|---|---|---|
| 10 | Client | 12 | Communication Network |
| 14 | Input Module | 16 | Server |
| 18 | Output Module | 20 | Presentation Module |
| 22 | Memory & Storage | 24 | Processing Module |
| 26 | Communication Interface | 28 | Bus |
| 30 | Front End | 32 | Processing Unit |
| 34 | Site Storage | 36 | Log Data Storage |
| 38 | Search Module | 40 | Log Processing System |
| 42 | Searching System | 44 | Display |
| 46 | Concise Summary | 48 | Advertisement |
| 50 | Pie Chart | 52 | Display |
| 54 | Concise Summary | 56 | Advertisement |
| 58 | Pie Chart | 60 | Display |
| 62 | Search Results | 64 | Advertisement |
| 66 | Pie Chart | 68 | Display |
| 70 | Concise Summary | 72 | Concise Summaries |
| 74 | Display | 76 | Concise Summary |
| 78 | Concise Summaries | 80 | Display |
| 82 | Concise Summary | 84 | Concise Summaries |

100, 102, 104, 106, 200, 202, 204, 206, 300, 302, 304, 306, 308, 310, 312
are steps.

### DETAILED DESCRIPTION

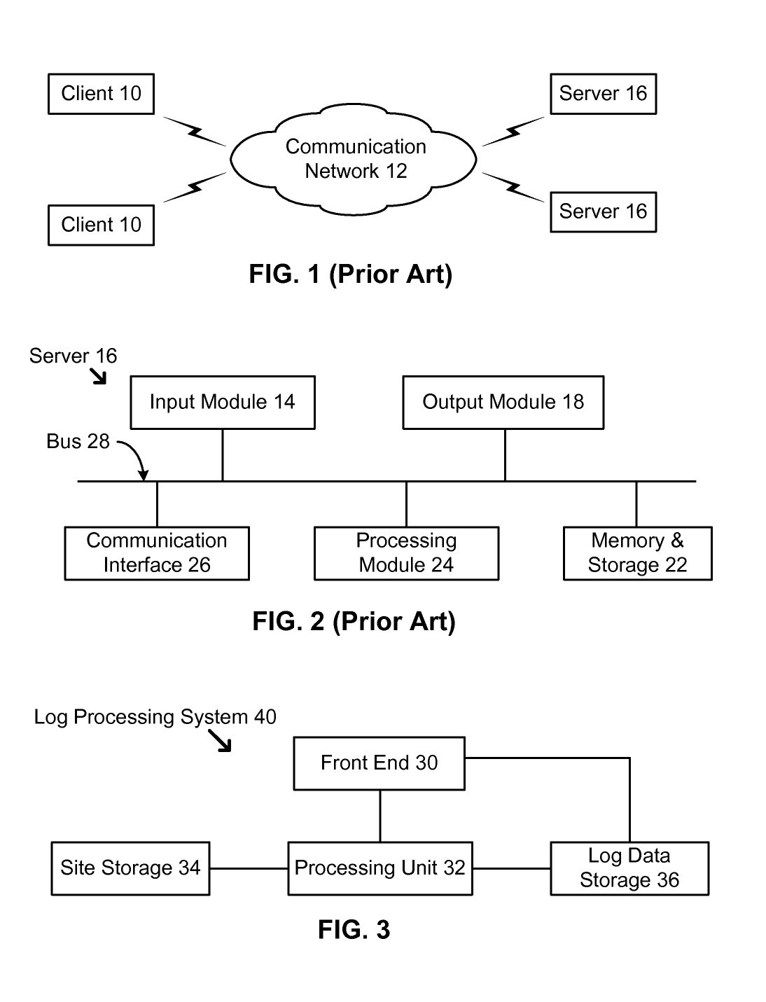

### FIGS. 1 and 2—Prior-Art

FIG. 1 is an exemplary diagram of a prior-art network system which may be used to implement the principles of current invention. The network system may comprise clients 10 and servers 16 which are connected via a communication network 12. The numbers of users and servers in FIG. 1 are arbitrary for illustrating principles only. The users or servers may be the same or different in characteristics and their functionality may change in practical applications.

Clients 10 may cover a range of entities such as a thread or process running on a devices, or an object executable by a device, an electronic device, e.g. a desktop computer, a handheld computer, a tablet computer, a wireless gadget (such as mobile phones, smartphones, personal digital assistants (“PDAs”)), digital television (DTV), internet protocol television (IPTV), play stations, etc.

The word “server” used in here means a system or systems which may have similar functions and capacities as one or more servers. Main components of server may include one or more processors, which control and process data and information by executing software, logic, or code, or carrying out any other suitable functions. A server and/or processor, as a computing device, may include any hardware, firmware, software, or a combination. In the most compact form, thanks to the progress of microelectronics, a server may be built on a single processor chip. In the figure, servers 16 may represent one or more server entities that collect, process, maintain, and/or manage information and documents, execute search requested by a user and deliver search results to the user.

Network 12 may also cover a range of entities such as a local area network (LAN), a wide area network (WAN), a telephone network, an intranet, the Internet, wireless, and other types of networks. Clients 10 and servers 16 may be connected to network 12 or among themselves by various wired, wireless, optical, direct or relayed connections.

FIG. 2 is a schematic block diagram of prior-art server 16 in FIG. 1. Server 16 may comprise an input device 14, an output device 18, a memory & storage module 22, a processing module 24, a communication interface 26, and a bus 28. Bus 28 provides communication means among the devices.

Input module 14 may comprise a function that permits and enables an operator to feed information to server 16. Keyboard, mouse, voice or gesture recognition devices are examples of module 14. Output module 16 presents or display output information. Examples of output module are monitor, printer, smart phone, or other information output devices. Memory & storage module 22 may comprises random access memory (RAM), read only memory (ROM), magnetic storage, optical storage, or other memory and storage media. Processing module 24 may comprise various types of processors which receive and execute instructions. Communication interface 26 may comprise any communication mechanism that enables server 16 to exchange information with other devices and systems either locally through bus 28 or remotely through network 12.

Processing module 24 may process information or documents obtained from various web pages within particular web sites, generate data associated with web sites, and then store the data using memory & storage 22. Module 24 may also access information stored in memory & storage 22 to acquire needed data. Module 24 may perform these operations in response to executable software instructions contained in a computer-readable medium, such the RAM or ROM part of device 22.

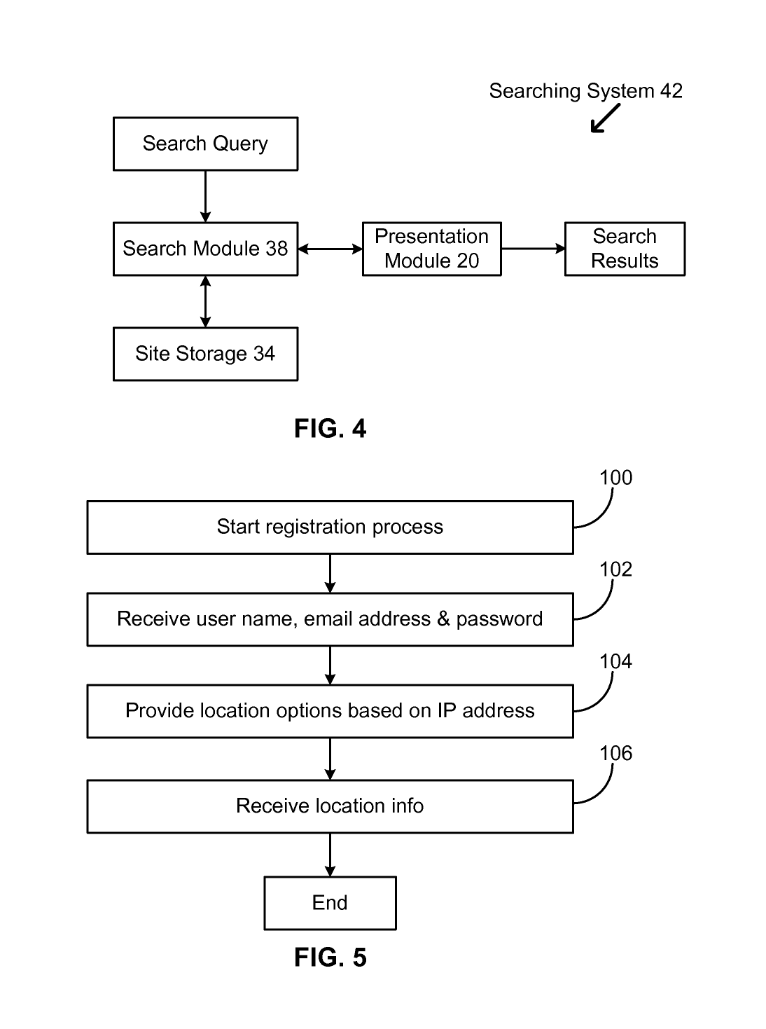

### FIGS. 3 and 4 Processor Functions

FIG. 3 is a schematic functional block diagram of a log processing system 40 of a server according to the present invention. System 40 may comprise a front end 30, a processing unit 32, site storage 34, and log data storage 36. The blocks each may represent processor, thread, and/or object. The blocks or functions depicted here and in other figures may be implemented in software, hardware, or a combination of hardware and software. Using integration or system-on-chip technology, system 40 and other systems described here may also be built by less blocks or chips, or even a single block or single chip to realize functions pursued, and to reduce the system size and power consumption.

Front end 30 works as the front end of log processing system 40 and receives information or document related to users and user access of web pages and web sites such as hypertext transfer protocol (HTTP) requests. Web access information of users includes visits on various sites and web pages where posts are displayed, which may be sent to and stored in log data storage 36. Log storage 36, as shown in FIG. 3, is directly connected to front end 30. It stores data transferred via front end 30, which may include other user related info which are either submitted by users or collected via other means, such as user name, password, IP address, geographic location, online posting record, online purchase record, etc.

Processing unit 32 may analyze a user by the information stored in log data storage 36 and send analysis results to site storage 34. The results may illustrate user activity, history, and habit while surfing on the Internet. Main functions of site storage 34 may include collecting and storing information on various subjects, especially posts on certain topics, which also comprises part of or all related documents retrieved by the server or through search engines of other web sites, such as Google and Bing. Information stored in site storage 34 may include collection of posts from major websites, other post-related media and multimedia like texts, video, audio, links to web pages, as well as web site related info such as site address, web page contents, visit history, and lists of website on selected issues.

FIG. 4 is a schematic functional block diagram of a searching system 42 of a server according to the present invention. The functions illustrated in FIG. 4 may be realized by software, hardware, or a combination of hardware and software. The blocks each may represent processor, thread, and/or object. And the blocks can be integrated into less blocks or even one block without changing the functions. A search query may be any text or symbol a user submits to searching system 42. After a query is received, system 42 may search the Internet accordingly, and combine the searching with previous search results stored in site storage 34 to produce consolidated results, which may be presented to the user by text, charts, web site lists or links, etc.

System 42 may comprise a search module 38 and a presentation module 20, while in practice the two modules may be integrated into one device. After search module 38 receives a search query from a user, it may analyze the query, identify the issue, access the Internet and site storage 34 to reach relevant documents, and then generate an initial search result, which is sent to presentation module 20. Module 20 may further process the result and arrange a way it is presented to a user and then send to the user the processed search result in text, charts, other graphic display, or other applicable forms. The functions of presentation module 20 may include data/information categorizing, sorting, filtering, summarizing, chart and curve drawing, and other ways to present a search result. The manner a search result is displayed is determined by user preference or analysis on user viewing history or a predetermined arrangement. As said, search module 38 may have the capacity to access documents on the Internet, or documents of other servers, and conduct search on the Internet or obtain search results utilizing external search engines like Google or Bing. This part, comprising searching using outside servers and websites, is not shown in FIG. 4 for simplicity reasons. After completing a search, search results and related data obtained locally and on the Internet may be recorded at site storage 34 for future use purpose. For identified hot subjects or issues, related posts and information may be collected and organized periodically to keep them up to date, such that upon receiving a query, search module may just access storage 34 to retrieve results without launching extensive searches.

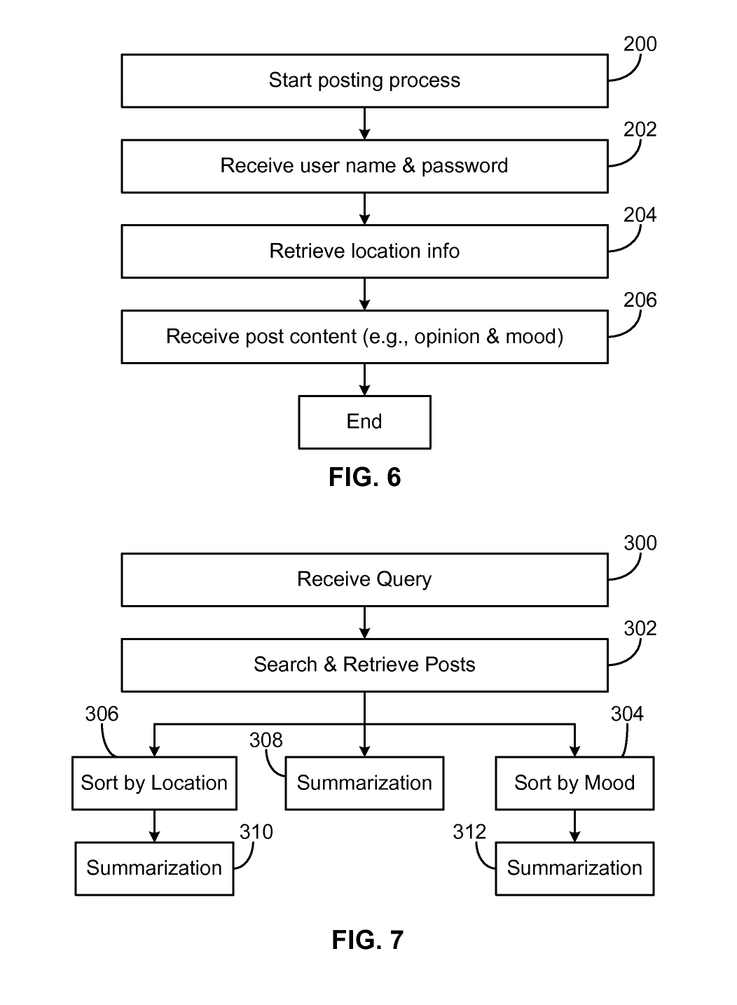

### FIGS. 5 and 6 Registration, Location Confirmation and Posting Process

FIG. 5 is a schematic flow diagram illustrating user registration and location confirmation process in accordance with the present invention. In Step 100, front end 30 receives data sent by client 10 via network 12 requesting registration. In Step 102, client 10 is asked to submit user name, email address, password, etc. Information provided by client 10 is stored in log data storage 36. Front end 30 may also be arranged to obtain the IP address of client 10 and sends the IP address to processing unit 32. Processing unit 32 compares related data in site storage 34 or log data storage 36 and as shown in Step 104, provides location options to client 10 via front end 30. The location options may include a geographic location based on the IP address and is presented to the user for verification purpose. The user preferably may be asked to confirm the location, but may also have another option to select another place as his or her location, which place is preferably close to the location derived from the IP address, assuming the user is close to home. In Step 106, front end 30 receives confirmation message about location from client 10, which is sent to and stored in log data storage 36. Then the registration process is completed. In case a user declines to confirm location info, the user account may be labeled either as no location info available or as location unconfirmed.

FIG. 6 shows schematically a flow diagram of posting process in accordance with the present invention. In Step 200, front end 30 receives a message sent by client 10 to request log in and starts the process. In Step 202, front end 30 receives account log-in information from the user and compares it with records stored in log data storage 36, including user name and password. In Step 204, front end 30 retrieves location information of the user from log data storage 36, and enables the user to begin post publishing process. In Step 206, front end 30 receives the content to be posted, passes it to a publication module to post it officially (this step is not shown in FIG. 6), and then sends the content to processing unit 32 which keeps it in site storage 34 (again not shown in FIG. 6). The post content may include symbol, sign, text, image, audio, video, web site contents, web site link, mood polarity information, etc. Mood information may be obtained from a checked item, or derived from the post. Mood polarity may comprise three states, happy, not happy or angry, and neutral, while other representation ways may apply, or more levels of mood status may be used. If the three-state mood polarity is employed, client 10 may be presented with three check boxes beside the post content on his or her display. As mood polarity is enough to reflect poster's stance on an issue, a post may contain mood information only.

### FIGS. 7-11 Search Result Processing and Presentation

FIG. 7 is an exemplary flow diagram of post search and processing performed by searching system 42 of FIG. 4 in accordance to present invention. In Step 300, search module 38 receives a comment query on a subject from client 10. In Step 302, search module 38 starts searching posts on the Internet and in site storage 34. Step 302 may be performed by searching site storage 34 if related info at the storage is updated regularly, and a search may also be conducted using outside search engines at google.com or bing.com. After searching is completed, related posts are collected and search results are sent to presentation module 20 of system 42. In Steps 304 and 306, sorting, categorizing, or filtering may be performed. For example, presentation module 20 may be used to sort initial search results by the location of poster or by the mood polarity of post. In Step 308, module 20 may be used to summarize the initial search results to produce a summary, especially a concise summary based on the original query. In Steps 310 and 312, the sorted results may be further processed by summarization.

Assume a search generates a large number of posts. It would be helpful if the posts are categorized or sorted such that only the relevant ones are presented to a user. The posts may be categorized or sorted by poster's geographic location in Step 306 and/or post mood polarity in Step 304. The grouped posts may then be presented in a table or a list. But for busy users, a table or list may still be too much to read through, especially for users on the run. Thus, Steps 310 and 312, like Step 308, may be employed to produce a concise summary. A concise summary may contain a short sentence, a chart, a curve, a few words, or even one word like “Good” or a grade like 65 points (out of 100 for example). A concise summary is especially useful for mobile device users on street or in a store, when the time is limited with impending decision making.

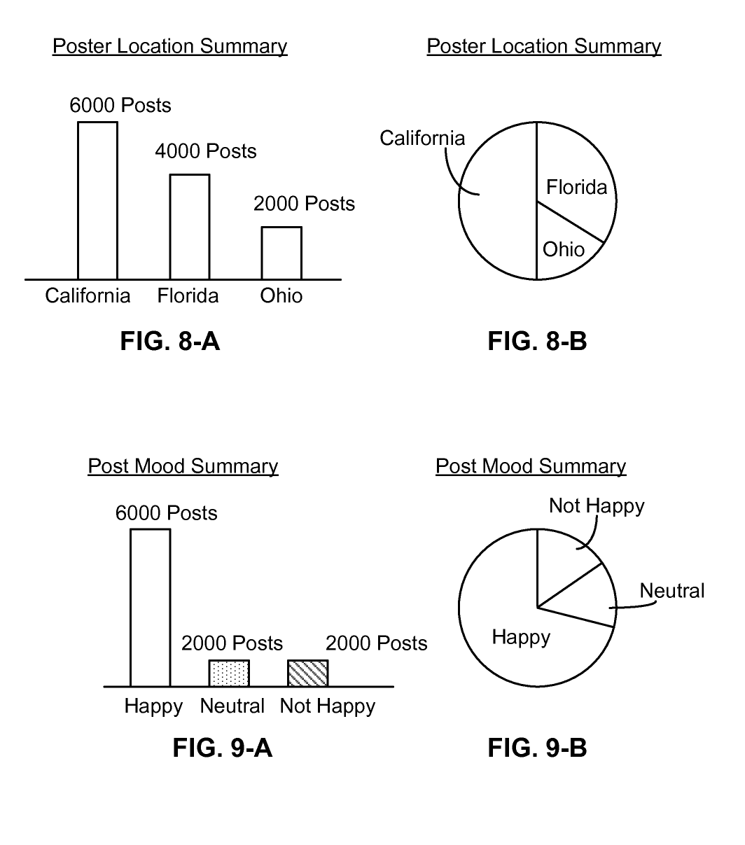

FIG. 8-A shows an exemplary chart where number of posts based on poster's state is displayed. The posts may be of comments on a social issue. The chart may be used to show resident response to the issue by states. As aforementioned, a post may include location info which may be obtained during user registration. Thus after search module 38 in FIG. 4 sends retrieved posts to presentation module 20, location information of posters, if available, may be identified by module 20. The location data may then be used to sort and summarize posts. Summarization results may be displayed by plain text, or used to draw a column chart like in FIG. 8-A. In another example, the data is transformed into a pie chart as in FIG. 8-B. The location may be of city, county, region, state, or country.

Similarly, FIGS. 9-A and 9-B show respectively column and pie charts representing summaries based on post mood polarity. The posts may be of comments on a product. Presentation module 20 may be arranged to retrieve mood info from each post, summarize the posts based on mood info, and then convert the summary into chart format. It is easy to see that there are far more happy (positive) posts than unhappy (negative) posts, though unhappy users take a sizable portion. A concise summary presented by chart is clear and convenient to understand for users.

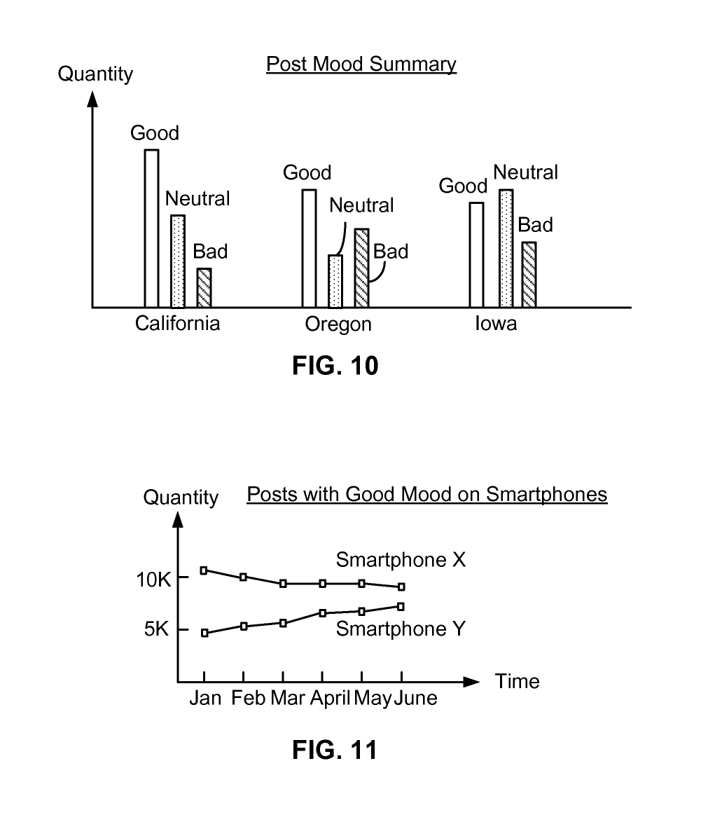

FIG. 10 shows an exemplary chart depicting post mood distribution in different states. The posts may be written targeting a controversial subject, such as a defective product, tax hike, gasoline price, etc. The chart may be made after two rounds of sorting. Firstly original search results on the subject are retrieved, and the data may be sorted by geographical location information, for example, by state. Secondly, the processed data may be sorted further according to each post's mood polarity and then summarized by calculating the total number of posts with one mood polarity in a state. The chart depicts a concise answer which is easy and quick to comprehend.

In FIG. 11, posts on smartphones X and Y are summarized and presented in an exemplary curve diagram. Search results are sorted by mood polarity, then sorted by months, and finally turned into a curve reflecting attitude change over a period of time, say from January to June. The diagram provides a clear comparison between smartphones X and Y in terms of public opinions and trend with time.

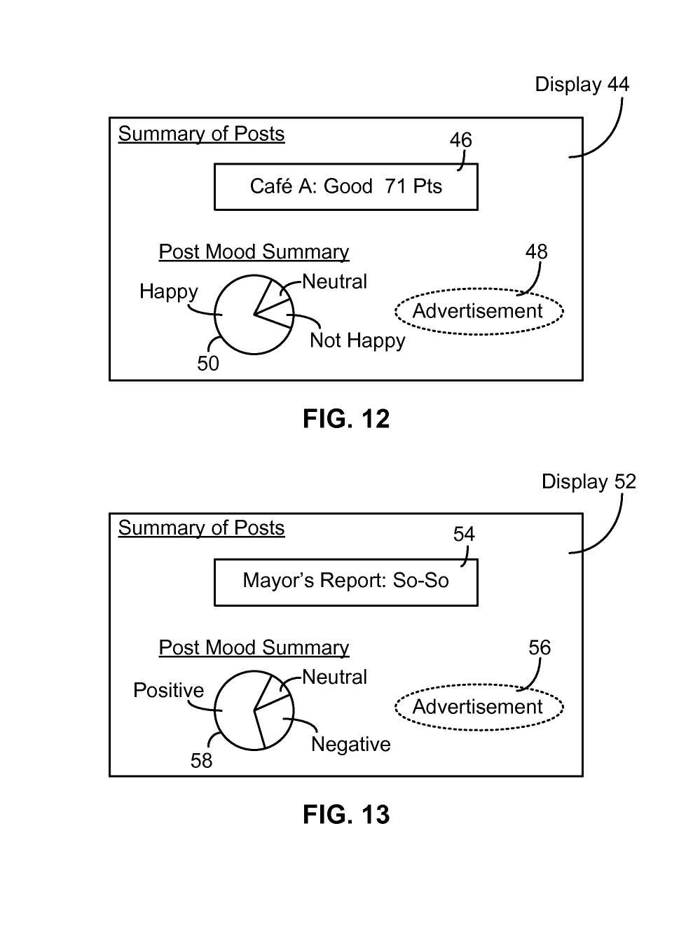

### FIGS. 12-17 Search Summaries and Presentation

A summary based on mood or location may be combined with a concise search summary derived from the original query and presented to a user together. Referring to FIG. 12, a user's display 44 may be arranged to present a regular concise summary 46 and a pie chart 50 depicting post mood summary. In the example, summary 46 “Good 71 Pts” may be derived from all search results on Café A. Chart 50, on the other hand, shows customer's feeling from a different angle. Also displayed is advertisement 48 which may be sponsored by a competitor café.

FIG. 13 shows a user's display 52 where search results on a mayor's report are presented. The mayor gets average marks as reflected by a concise summary 54. A pie chart 58 indicates the ratio between positive and negative mood among posts. And there may be a sponsored message 56 placed by a political group. Concise summaries 54 and 58 illustrate the response in respect to the mayor report in a straightforward and clear way.

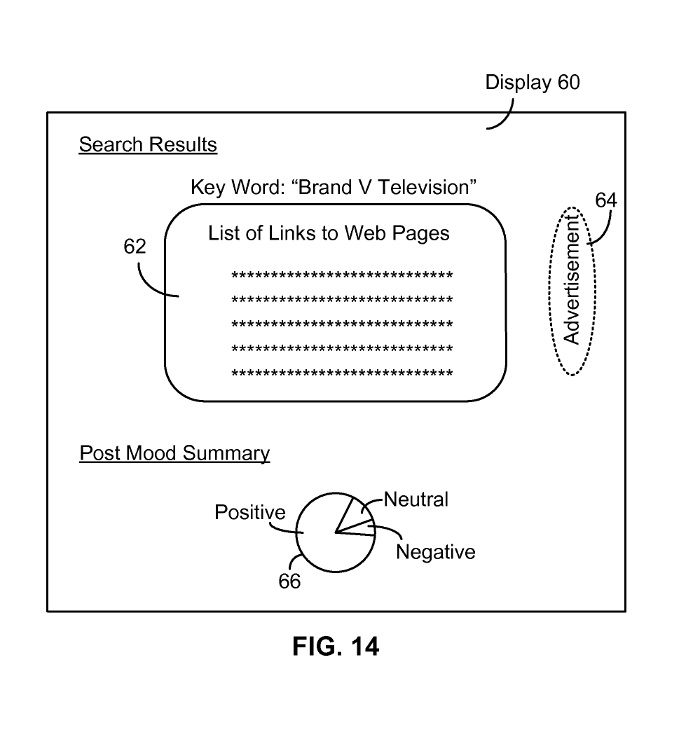

In FIG. 14 a regular search result 62 and a pie chart 66 about “Brand V Television” are presented together on a display 60. Result 62 contains a list of links which are connected to relevant web pages. Normally, a list of links is all a search engine provides. But chart 66 adds more contents to the search result. It shows the ratio of posts with positive, negative, or neutral mood polarity on the television. Thus besides regular info, a user may have a quick grasp about general opinions on the product. Again, a sponsored message 64 is placed on the display.

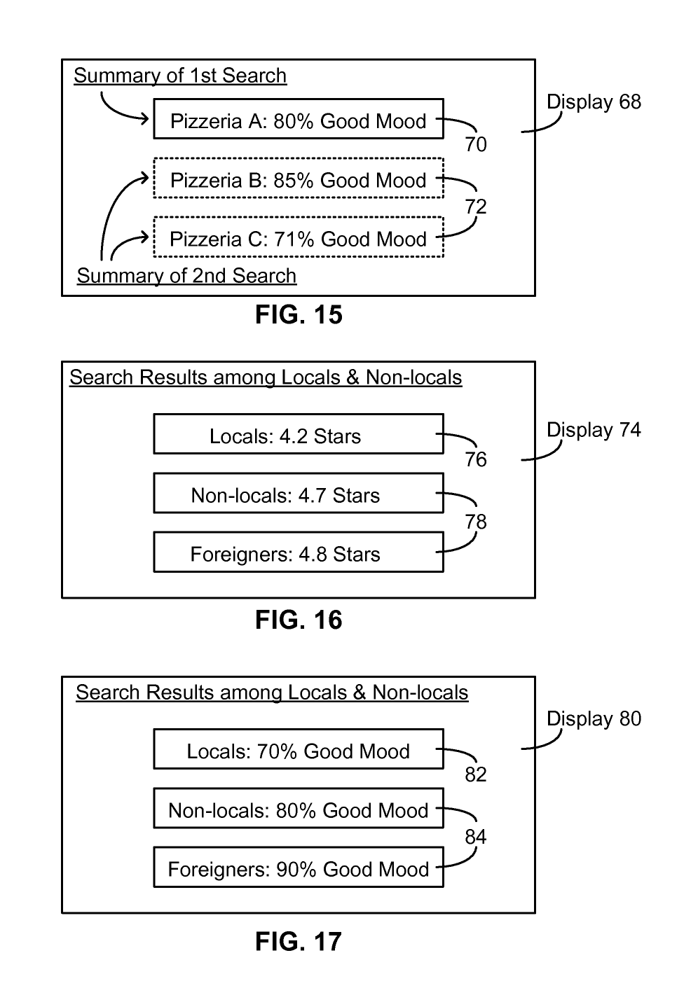

FIG. 15 shows multiple concise search summaries configured on a display 68 exemplarily. The original search is about Pizzeria A. A summary 70 yields “80% Good Mood”, meaning 80% of comments have positive mood polarity. In reality, one number or grade alone has limited value. Thus it may be arranged such that a second search is conducted automatically where the query subjects are Pizzeria B and Pizzeria C located in the same region. Search results “85% Good Mood” and “71% Good Mood” are displayed by concise summaries 72. By comparing results on competing eateries, it becomes more convenient for users to make a decision. It is noted that the second search is initiated automatically and it helps a user by staging a comparison.

FIGS. 16 and 17 are used to explore benefits of concise search summaries based on poster's geographic location. Assume a search query is about a retail store in a big city. The search results are shown on displays 74 and 80. On display 74, concise summaries 76 and 78 contain a grade only. Summary 76 focuses on comments/posts made by the locals, while summaries 78 target non-locals and foreign travelers respectively. In a similar manner, display 80 shows search summaries based on locals, non-locales, and foreigners, while the aim is at mood polarity. As a result, grades given by locals and non-locales are displayed clearly and concisely, and so is the mood polarity. Travelers as well as local people may be able to have a quick look to get the essence of posts/comments, that is, the business is more favored by non-locals, especially international tourists. In FIG. 16, initial search results are sorted three times based on three location factors: local, non-local, and foreigner. In FIG. 17, search results may be sorted three times by locations first, followed by three more sorting processes based on mood polarity.

### CONCLUSION, RAMIFICATIONS, AND SCOPE

Thus it can be seen that apparatus and methods are introduced to retrieve, process, and present search results on online posts.

The described embodiments have the following features and advantages:
(1). Categorize or sort posts by poster's geographic location;
(2). Categorize or sort posts by mood polarity;
(3). Generate concise post summary based on location and/or mood polarity;
(4). Present a regular post summary along with a summary based on location and/or mood polarity;
(5). Confirm poster's geographic location.

Although the description above contains many specificities, these should not be construed as limiting the scope of the invention but as merely providing illustrations of some of the presently preferred embodiments. Numerous modifications will be obvious to those skilled in the art.

### Ramifications:

A regular search result having list of links to web pages may be combined with multiple concise summaries and presented to a user. For example, in FIGS. 15, 16, and 17, a list of links to web pages may be added to provide options for users to explore in detail.

Various survey results on a subject conducted by a business or organization may be treated as user generated content or comments.

Search summaries of different types may be generated and presented to a user automatically when applicable.

Lastly, in a searching process, a search result retrieving step and sorting/filtering step may be combined into one step, which may selectively retrieve data from the Internet based on location and/or mood polarity.

Therefore the scope of the invention should be determined by the appended claims and their legal equivalents, rather than by the examples given.

1. A system comprising one or more computing devices for providing processed information through searching and processing, comprising:
1) receiving means for receiving a search query at said one or more devices from one of a plurality of users via a communication network;
2) retrieving means for retrieving a plurality of search results based on said search query by said one or more devices, the majority of said search results comprising content originated from part of said plurality of users;
3) processing means for processing said search results by said one or more devices;
4) said retrieving means and/or processing means comprising at least one of the following processing sub-means:
(a) first sub-means for obtaining and/or filtering said search results using content originator's geographic location information;
(b) second sub-means for obtaining and/or filtering said search results using content mood polarity information;
(c) third sub-means for summarizing said search results based on content originator's geographic location information and/or content mood polarity information; and
5) transmitting means for transmitting the processed search results from said one or more devices to said one of a plurality of users via said communications network.

2. The system according to claim 1 wherein said search query is transmitted to said one or more devices via a mobile apparatus.

3. The system according to claim 1, further including producing means for producing at least one substantially concise summary.

4. The system according to claim 1, further including first presenting means for graphically providing the processed search results to said one of a plurality of users.

5. The system according to claim 1, further including ad means for providing sponsored content to said one of a plurality of users.

6. The system according to claim 1, further including second presenting means for providing to said one of a plurality of users at least a first summary based on said query and a second summary based on the geographic location information and/or mood polarity information.

7. The system according to claim 1, further including third presenting means for providing to said one of a plurality of users at least two summaries based on the geographic location information and/or mood polarity information.

8. A method performed by one or more computing devices comprising:
1) receiving a search query at said one or more computing devices from one of a plurality of users via a communication network;
2) retrieving a plurality of search results based on said search query by said one or more computing devices, the majority of said search results comprising content originated from part of said plurality of users;
3) processing said search results by said one or more computing devices;
4) said retrieving step and/or processing step comprising at least one of the following processing sub-steps:
(a) obtaining and/or filtering said search results using content originator's geographic location information;
(b) obtaining and/or filtering said search results using content mood polarity information;
(c) summarizing said search results based on content originator's geographic location information and/or content mood polarity information; and
5) transmitting the processed search results from said one or more computing devices to said one of a plurality of users via said communications network.

9. The method according to claim 8 wherein said search query is transmitted to said one or more computing devices via a mobile apparatus.

10. The method according to claim 8, further including generating at least one substantially concise summary.

11. The method according to claim 8, further including graphically providing the processed search results to said one of a plurality of users.

12. The method according to claim 8, further including providing sponsored content to said one of a plurality of users.

13. The method according to claim 8, further including providing to said one of a plurality of users at least a first summary based on said query and a second summary based on the geographic location information and/or mood polarity information.

14. The method according to claim 8, further including providing to said one of a plurality of users at least two summaries based on the geographic location information and/or mood polarity information.

15. A method performed by one or more computing devices comprising:
1) receiving user information from a user device by one of a plurality of users via a communication network;
2) obtaining first geographic location information from said user device;
3) providing options to said one of a plurality of users to confirm said first geographic location information or to submit second geographic location information;
4) receiving response from said one of a plurality of users via said communications network, said response including confirmation of said first geographic location information or submission of said second geographic location information or other related information; and
5) recording the response using said one or more computing devices.

16. The method according to claim 15 wherein said user device is a mobile apparatus.

17. The method according to claim 15, further including sorting a plurality of search results using said first and/or second location information.

18. The method according to claim 15, further including summarizing a plurality of search results using said first and/or second location information.

19. The method according to claim 15, further including performing a search on the Internet using said first and/or second location information.

20. The method according to claim 15 wherein said obtaining step includes utilizing IP address of said user device.
